(19) United States
(12) Patent Application Publication
(10) Pub. No.: US 2013/0027658 A1
(43) Pub. Date: Jan. 31, 2013

(54) EYEGLASS ASSEMBLY

(71) Applicant: JUI-CHI LI, TAINAN CITY (TW)

(72) Inventor: JUI-CHI LI, TAINAN CITY (TW)

(73) Assignee: SUN SIGHT GLASSES CO., LTD., TAINAN (TW)

(21) Appl. No.: 13/327,983

(22) Filed: Dec. 16, 2011

(30) Foreign Application Priority Data
Jul. 29, 2011 (TW) 100214020

(51) Int. Cl. G02C 9/00

(52) U.S. Cl. 351/57

(57) ABSTRACT

An eyeglass assembly is revealed. The eyeglass assembly includes an eyeglass main body and an accessory frame. A mounting groove is disposed on an upper part of a bridge of the eyeglass main body and two locking slots are respectively arranged at each of two sides on a front surface of the eyeglass main body. Moreover, mounting blocks are arranged at an upper part of a bridge part on a rear surface of the accessory frame. The mounting blocks are mounted into the mounting groove of the eyeglass main body correspondingly. Locking blocks are disposed projectingly on each of two sides of the rear surface of the accessory frame to be mounted into the locking slots of the eyeglass main body. Thereby the eyeglass main body and the accessory frame are respectively assembled with different type of lens and then are fastened with each other tightly by three points.

### BACKGROUND OF THE INVENTION

1. Field of the Invention

The present invention relates to an eyeglass assembly, especially to an eyeglass assembly including an eyeglass main body and an accessory frame respectively mounted with different type of lens and secured with each other tightly by three points.

2. Description of Related Art

In order to prevent damages to eyes from harmful ultraviolet rays, people wear sunglasses at all times outdoors.

For consumers with different taste, sunglasses generally have different designs of styles besides the anti ultraviolet function. In contrast, the prescription sunglasses are made for individuals so they lack prevalence in the market and can't be mass produced. Thus the prescription sunglasses are of high cost and the styles are limited. Most of manufactures are not interested in this market.

However, along with the popularity of televisions and computers, more and more people have near-sighted and there is a descending trend on the age of near-sighted people. Thus more people need to wear glasses for improving their eyesight. The sunglasses without prescription can't meet such requirement. The manufactures are focused on finding sunglasses not only have different styles but also suits users with different powers.

There is room for improvement and a need to provide an eyeglass assembly that overcomes the above shortcomings.

### SUMMARY OF THE INVENTION

Therefore it is a primary object of the present invention to provide an eyeglass assembly having an eyeglass main body and an accessory frame respectively disposed with different type of lens for multiple functions. Moreover, the eyeglass main body and the accessory frame are assembled with each other stably.

In order to achieve the above object, an eyeglass assembly of the present invention includes an eyeglass main body and an accessory frame. A mounting groove is disposed on an upper part of a bridge of the eyeglass main body and two locking slots are respectively arranged at each of two sides on a front surface of the eyeglass main body. Two lens assembly parts are respectively set on each of two sides of the bridge of the eyeglass main body. Moreover, mounting blocks are arranged at an upper part of a bridge part on a rear surface of the accessory frame and are mounted to the mounting groove of the eyeglass main body correspondingly. A locking block is disposed projectingly on each of two sides of the rear surface of the accessory frame and is mounted into the corresponding locking slot at each side of the front surface of the eyeglass main body. On each of two sides of the bridge part of the accessory frame, there is also a lens assembly part formed.

The mounting groove of the eyeglass main body is step-shaped. The mounting blocks of the accessory frame are separated with each other and each having a hook projecting from the side thereof so as to lock with a step area of the mounting groove.

The lens assembly part of the eyeglass main body consists of a mounting edge and an opening. The mounting edge is formed around an upper edge and a lower edge of the lens assembly part and an edge of the bridge while the opening is set on an outer side of the lens assembly part, opposite to the bridge.

Thereby the eyeglass main body and the accessory frame are respectively mounted with different type of lens and are fixed by three points on a center and two sides between the eyeglass main body and the accessory frame. Thus the eyeglass main body and the accessory frame are assembled with each other stably. Moreover, a lens is inserted through the opening and is locked tightly by the mounting edge. Thus easy and convenient assembly of the lens is achieved due to the design of the lens assembly part.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a perspective view of an embodiment according to the present invention;

FIG. 3 is a cross sectional view of an embodiment according to the present invention;

FIG. 4 is a partial enlarged cross sectional view of an embodiment according to the present invention;

FIG. 5 is a schematic drawing showing a lens being assembled into an embodiment according to the present invention.

### DETAILED DESCRIPTION OF THE PREFERRED EMBODIMENT

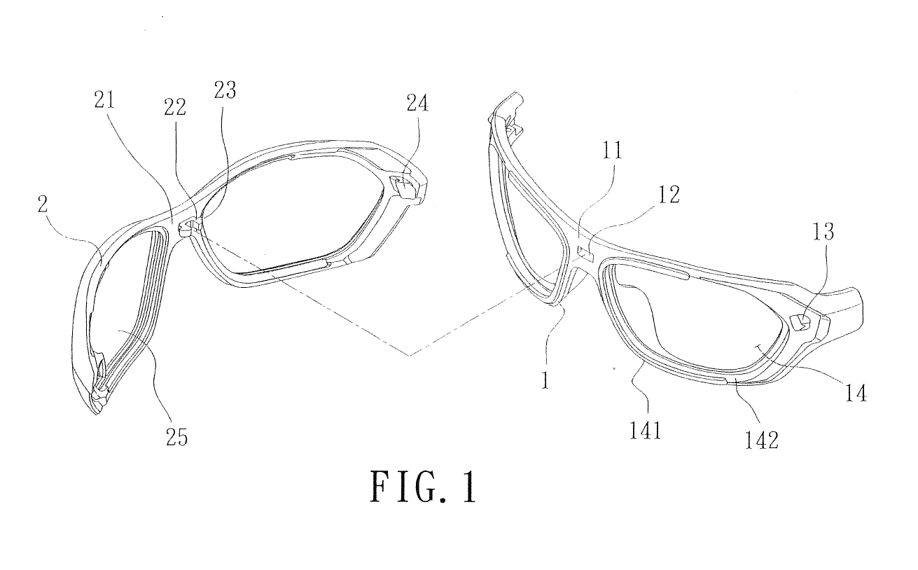

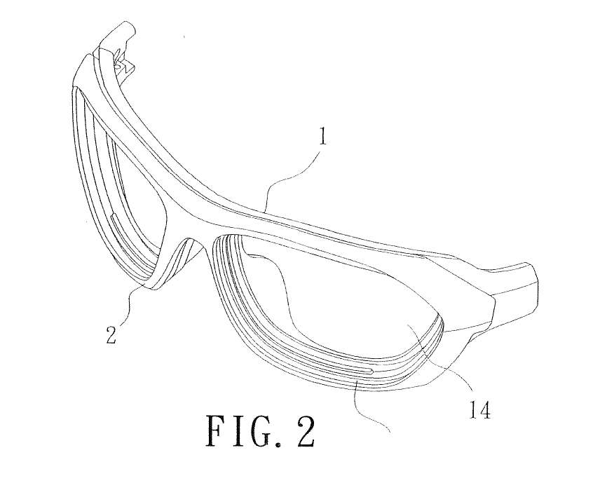

Refer to FIG. 1 to FIG. 2, an eyeglass assembly includes an eyeglass main body 1 and an accessory frame 2.

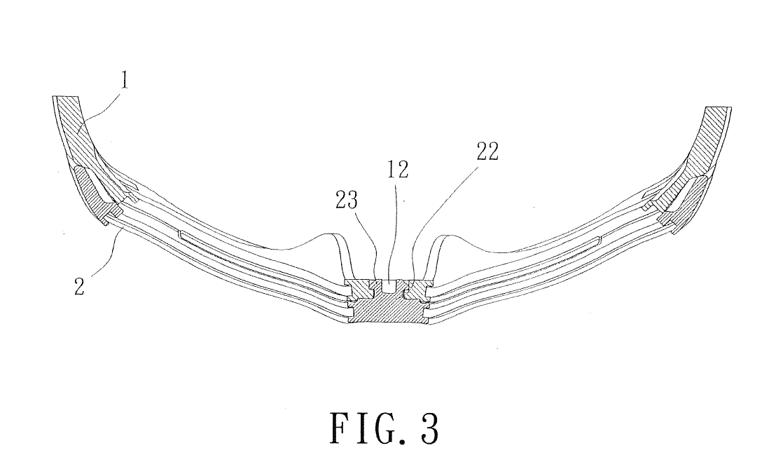

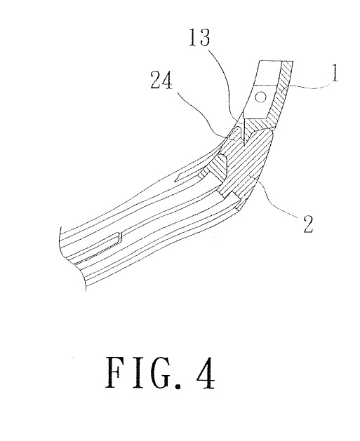

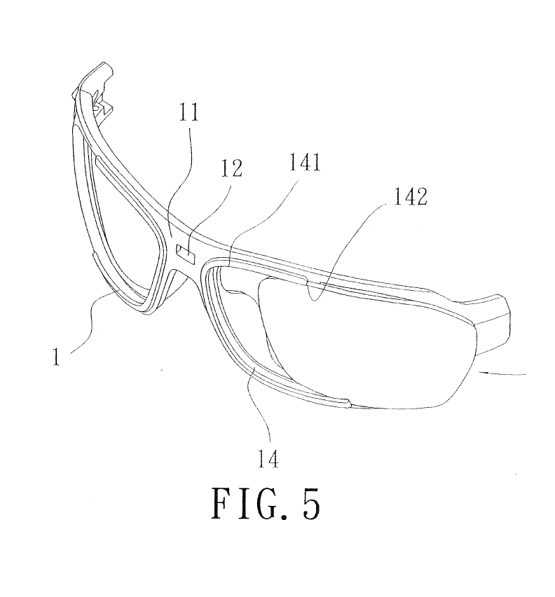

The eyeglass main body 1 consists of a bridge 11, a step-shaped mounting groove 12, two locking slots 13 and two lens assembly parts 14. The step-shaped mounting groove 12 (as shown in FIG. 3) is disposed on an upper part of a bridge 11 of the eyeglass main body 1. The two locking slots 13 are respectively arranged at each of two sides on a front surface of the eyeglass main body 1. The lens assembly parts 14 are respectively set on each of two sides of the bridge 11 of the eyeglass main body 1. The lens assembly part 14 is composed of a mounting edge 141 and an opening 142. The mounting edge 141 is formed around an upper edge and a lower edge of the lens assembly part 14 and an edge of the bridge 11 while the opening 142 is set on an outer side of the lens assembly part 14, opposite to the bridge 11, as shown in FIG. 4 and FIG. 5. Moreover, two temples are respectively disposed on each of two sides of the eyeglass main body 1.

The accessory frame 2 includes a bridge part 21, two separate mounting blocks 22, two hooks 23, two locking blocks 24 and two lens assembly parts 25. The mounting blocks 22 are arranged at an upper part of the bridge part 21 on a rear surface of the accessory frame 2 and are mounted to the mounting groove 12 of the eyeglass main body 1 correspondingly. Each hook 23 projects from the side of each mounting block 22 so as to lock with a step area of the mounting groove 12, as shown in FIG. 3. Each of the two locking blocks 24 is disposed projectingly on each of two sides of the rear surface of the accessory frame 2. The locking blocks 24 are mounted into the locking slots 13 on the front surface of the eyeglass main body 1, as shown in FIG. 4. Moreover, the lens assembly parts 25 are respectively located on two sides of the bridge part 21 of the accessory frame 2.

Refer to FIG. 5, while in use, one of various types of lenses such as an optical lens, an ultraviolet (UV) protection lens, a polarizer (Polaroid film), an eye protection film, etc is inserted through the opening 142 on the outer side of the lens assembly part 14 and then is mounted into the lens assembly part 14 by the mounting edge 141 around the upper edge, the lower edge and the edge of the bridge 11 of the assembly part 14. Another type of lens is assembled on the lens assembly part 25 of the accessory frame 2.

In daily lives, the user can wear the eyeglass main body 1 assembled with one kind of lens such as optical lens, ultraviolet (UV) protection lens, polarizer (Polaroid film), eye protection film, etc. to help him deal with his works.

When the user needs to do something else, he can take the accessory frame 2 with different type of lens. Refer to FIG. 2 and FIG. 3, the mounting blocks 22 of the accessory frame 2 are mounted into the mounting groove 12 of the eyeglass main body 1. Due to a gap formed between the two mounting blocks 22, the two mounting blocks 22 with the hooks 23 are retracted and mounted into the mounting groove 12 and then extended at the step area on the inner side of the mounting groove 12. The projected hook 23 on the side of each mounting block 22 is hooked with and positioned at the step area of the mounting groove 12. Refer to FIG. 4, the locking block 24 projected from each of two sides of the accessory frame 2 is locked and positioned into the locking slot 13 at each of two sides on the front surface of the eyeglass main body 1 so as to form a stable three point support between the area above the bridge part 21, two sides of the accessory frame 2, and the eyeglass main body 1. Thus the accessory frame 2 is secured on the eyeglass main body 1 firmly, without dangling or falling apart.

Thus by the accessory frame 2 with another type of lens, the user can handle another work. After completing the that matter, the user can apply force to release each locking block 24 of the accessory frame 2 from the locking slot 13 on each of two sides of the eyeglass main body 1 in turn. Then press the two separate mounting blocks 22 to move toward each other so as to make the hook 23 release from the step area of the mounting groove 12 of the eyeglass main body 1. Thus the retracted mounting blocks 22 can be removed out of the mounting groove 12 of the eyeglass main body 1 easily. The accessory frame 2 and the eyeglass main body 1 are disconnected quickly.

According to users' requirements, the eyeglass main body 1 assembled with the optical lens, the UV protection lens, the polarizer, or the eye protection film is used together with the accessory frame 2 having another type of lens so as to provide dual functions. The single-piece shaped accessory frame 2 occupied little space is portable. Moreover, the accessory frame 2 can be designed with various styles and patterns for users to select and use. Compared with conventional sunglasses with different degrees with high cost, difficulty in carrying and a single style unable to be changed according to the user's costume or the occasion used, the present invention provides users more and better options.

In summary, the present invention has following advantages:

1. The eyeglasses of the present invention includes a mounting groove and locking slots on the upper part of the bridge and the two sides on the front surface of the eyeglass main body respectively so as to be assembled with the mounting blocks and locking blocks of the accessory frame correspondingly. Thus the stable three point support is formed so as to fasten the eyeglass main body and the accessory frame tightly and prevent dangling and falling of the assembly.

2. By the design of the mounting groove, the locking slots, mounting blocks and locking blocks that can be connected and disconnected easily and conveniently, the eyeglass main body and the accessory frame are assembled with each other. Thus users can assemble and disassembled the accessory frame more convenient.

3. The accessory frame is single-piece shaped. Thus users can carry the accessory frame easily and the storage of the accessory frame is convenient.

4. The accessory frame is designed with various types of styles and patterns. Thus users can select and change the accessory frame according to their costume and occasions required. Thus the present invention is of higher practical value.

5. The lens assembly part includes the mounting edge formed around the upper edge and the lower edge of the lens assembly part and the edge of the bridge while the opening is set on an outer side of the lens assembly part, opposite to the bridge. The lens is inserted through the opening and then is locked and fixed by the mounting edge of the lens assembly part firmly. Thus the lens is assembled easily and conveniently.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An eyeglass assembly comprising: an eyeglass main body and an accessory frame;
wherein at least one mounting groove is disposed on an upper part of a bridge of the eyeglass main body and a locking slot is arranged at each of two sides on a front surface of the eyeglass main body; two lens assembly parts are respectively set on each of two sides of the bridge of the eyeglass main body;
at least one mounting block is arranged at an upper part of a bridge part on a rear surface of the accessory frame and is mounted to the mounting groove of the eyeglass main body correspondingly; a locking block is disposed projectingly on each of two sides of the rear surface of the accessory frame and is mounted into the locking slot at each side of the front surface of the eyeglass main body; each of two sides of the bridge part of the accessory frame is also arranged with a lens assembly part.

2. The device as claimed in claim 1, wherein the mounting groove of the eyeglass main body is step-shaped and there are two separate mounting blocks of the accessory frame and each mounting block having a hook projecting from one side thereof so as to lock with a step area of the mounting groove.

3. The device as claimed in claim 2, wherein a mounting edge is formed around an upper edge and a lower edge of the lens assembly part and an edge of the bridge while an opening is set on an outer side of the lens assembly part, opposite to the bridge.

4. The device as claimed in claim 3, wherein two sides of the eyeglass main body are respectively disposed with a temple.

5. The device as claimed in claim 1, wherein a mounting edge is formed around an upper edge and a lower edge of the lens assembly part and an edge of the bridge while an opening is set on an outer side of the lens assembly part, opposite to the bridge.

6. The device as claimed in claim 5, wherein two sides of the eyeglass main body are respectively disposed with a temple.

7. The device as claimed in claim 1, wherein two sides of the eyeglass main body are respectively disposed with a temple.
